(19) United States
(12) Patent Application Publication
(10) Pub. No.: US 2024/0116145 A1
(43) Pub. Date: Apr. 11, 2024

(54) VARIABLE CONTROL LOGIC FOR ROTATING MACHINERY

(71) Applicant: HydroPoint, LLC, Chattanooga, TN (US)

(72) Inventor: Michael T. Ferris, Hixson, TN (US)

(73) Assignee: HydroPoint, LLC, Chattanooga, TN (US)

(21) Appl. No.: 18/483,941

(22) Filed: Oct. 10, 2023

Related U.S. Application Data
(60) Provisional application No. 63/415,031, filed on Oct. 11, 2022.

(51) Int. Cl. B23P 6/00; B23Q 1/26; F03B 13/08

(52) U.S. Cl. CPC B23P 6/002; B23Q 1/26; F03B 13/08; F05B 2230/80; F05B 2260/80

(57) ABSTRACT

A boring bar system sized and configured for removable in-situ placement within a cylindrically-shaped worksite, such as a hydro turbine-powered dam. The system configured for use in inspecting or maintaining a fixedly and non-removably located work surface at the work site comprises a boring bar. The boring bar includes a vertically oriented rotating main shaft, a pair of stationary spiders, a pair of supports, and a tool arm. The tool arm contains a tool and a variety of mounting locations, or machine slides, to selectively vertically and radially position the tool. The system further comprises a drive control unit (DCU) configured to rotate the main shaft using a drive unit and a variable control drive logic that continuously alters a frequency of the DCU to produce a non-uniform pulsation of the drive unit. As the DCU rotates the main shaft, the tool contacts the work surface.

### CROSS-REFERENCE TO RELATED APPLICATIONS

This application claims the benefit of U.S. Provisional Application No. 63/415,031 filed Oct. 11, 2022, and entitled Variable Control Logic for Rotating Machinery, which is incorporated herein by reference in its entirety.

### FIELD

This invention relates generally to precision field machining. More particularly, the invention relates to a precision field machining apparatus and method for reducing or eliminating undesirable harmonics from occurring during machining operations.

### BACKGROUND

With initial reference to FIG. 1, the general structure and components of a conventional hydropower plant 100 are shown. Hydropower plants, like plant 100, use a dam 102 to store water in a reservoir 104. Water released from the reservoir 104 flows through a turbine 106, spinning it, which in turn activates a generator 108 to produce electricity, which is then supplied to the power grid via a transformer 110, and power lines 112.

As with any mechanical system, periodic monitoring and maintenance of dams are necessary to ensure continued, safe, and optimal performance. The turbines that produce hydropower are designed for long periods of operation between major overhauls, but eventually every unit must be completely disassembled for major maintenance. Hydro turbines have large structural components that are embedded in concrete that cannot be removed for rehabilitation. For example, as shown in FIG. 2, stay rings 113 and stay vanes 114, discharge rings 116, and flange faces 118 that surround the turbine 106 are all typically embedded in the concrete that forms the dam 102. As such, these and other similarly embedded components cannot be easily removed, and maintenance work must be performed on these components in place (or “in-situ”).

The nature of this maintenance work has required the development of specialized machine tools called boring bars, which enabled in-situ machining operations to occur within the dam. With reference to FIGS. 3 and 4, a conventional boring bar 120 is shown. As shown, boring bars 120 generally include a rotating main shaft 122 having a top end 124 and a bottom end 126. An upper stub shaft 128 is mounted to the top end 124 of the main shaft 122 and a lower stub shaft 130 is mounted to the bottom end 126 of the main shaft. An upper spider 132 is located at the top end 124 of the main shaft 122 where the main shaft is joined together with the upper stub shaft 128. Similarly, a lower spider 134 is located at the bottom end 126 of the main shaft 122 where the main shaft is joined together with the lower stub shaft 130. Each of the spiders 132, 134, in conjunction with bearing assemblies (discussed below), function as support and positioning devices for correctly positioning or orienting the ends 124, 126 of the main shaft 122. The spiders 132, 134 each include a plurality of arms 136 that radiate outwards and surround the main shaft 122 of the boring bar 120. The free end of each arm 136 (i.e., the end located opposite the main shaft 122) is mounted to a fixed location at the worksite in order to securely fix the spiders 132, 134 in place.

The main shaft 122 is rotated by a drive 138 that is attached to one of the ends 124, 126. The main shaft 122 is equipped with one or more tool arm assemblies 140 that are configured to support machining devices, including slide mounted single-point tools and milling machines, for carrying out the various machining and other repairs needed at the worksite. The rotational motion of the main shaft 122 is facilitated by bearings located within bearing assemblies located at each of the ends 124, 126. In particular, an upper bearing assembly 142, which houses first bearings 144, is mounted to a top surface of the upper spider 132, such that the first bearings engage with the upper stub shaft 128. Similarly, a lower bearing assembly 146, which houses second bearings 148, is mounted to a top surface of the lower spider 134, such that the second bearings engage with the lower stub shaft 130.

A major concern in maintaining and machining the various components of hydropower dams is ensuring that the work is performed precisely and within certain tolerances. Often, very tight tolerances, measured in thousandths of an inch, are required to keep the various components of the dam, including the turbine itself, in proper horizontal and vertical alignment and to provide the running clearances necessary to maintain effective operation of the entire system. Consistent machining operations and consistent surface finishes are important for meeting these tolerances.

However, an enemy of consistent machining and surface finishes is vibrations—also known as chatter or harmonics—that occur in the machine tool during machining operations. Interrupted cuts, where the cutting and machining operation are not smooth and continuous, such as when machining over openings or other surface features that are uniform in size and spacing, are a major source of vibrations when machining. Harmonic vibrations can develop in the machined part when the machining tool being used is operated at a consistent operating speed in the vicinity of these types of consistent surface features. This vibration can negatively impact and even ruin the surface finish of the machined part. Inconsistencies and less than ideal surface finishes may also result when the rotating main shaft 122 is not sufficiently stiff. As mentioned above and as shown best in FIG. 4, the design of this this conventional boring bar 120 places the upper bearing assembly 142 and first bearings 144 in contact with the upper stub shaft 128 and places the places the lower bearing assembly 146 and second bearings 148 in contact with the lower stub shaft 130 and not in contact with the main shaft 122. Since the upper and lower stub shafts 128, 130 are merely joined with the main shaft 122 and are not formed as a unitary or continuous portion of the main shaft, this design is inherently less stiff than if the bearings were in contact with the main shaft.

While eliminating these vibrations is not entirely possible, it is important to minimize vibrations in order to provide consistent machining and surface finish. Conventional methods for reducing vibrations include increasing the mass and stiffness of the machining tools used and also adding dampening material to the machining tools used. These “brute force” methods result in unwieldy machine tools that are expensive and heavy. While these methods might be more acceptable for machining operations that take place in a stationary location, such as at a machine shop, they are impractical for field machining operations where the machining tools are moved from one site to another site. Another method for reducing vibrations is by slowing machining operations and machine tool indexing. The “indexing” of a machining tool controls the depth of the cut being made, including whether a heavy or light cut is made, and the resulting amount of material that is removed by the machining operation.

What is needed, therefore, is a boring bar system and method of use that reduces undesirable vibrations within the machining tool without manipulating the mass, stiffness, and/or dampening of the machine and the permits for more aggressive machining and indexing speeds while also meeting surface finish tolerance requirements.

### Notes on Construction

The use of the terms “a”, “an”, “the” and similar terms in the context of describing embodiments of the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both moveable and rigid attachments or relationships, unless otherwise specified herein or clearly indicated as having a different relationship by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing a boring bar system sized and configured for removable in-situ placement within a cylindrically-shaped worksite. The boring bar system is configured for use in inspecting or maintaining a work surface that is fixedly and non-removably located at the worksite. In certain embodiments, the worksite is a hydro turbine-powered dam, and the work surface is at least one of a stay ring, a stay vane, a discharge ring, or a flange. The system comprises a boring bar.

The boring bar may have a vertically oriented rotating main shaft having a top end and a bottom end. The main shaft is configured to rotate entirely about a central vertical axis extending through a center of the top end and bottom end of the main shaft.

The boring bar also has a pair of stationary spiders configured to support and to correctly locate a position of each of the top and bottom ends of the main shaft with respect to the worksite. Each of the pair of spiders has a plurality of outwardly radiating horizontally oriented arms. Each of the arms includes a fixed end that is fixed to the spider and an opposing free end that is configured to removably mount to the worksite. In certain embodiments, each of the pair of spiders further comprises an upper horizontal surface. A safety work platform is disposed on the upper horizontal surface of at least one of the spiders.

The boring bar further has a pair of supports that are each directly and exclusively mounted between one of the pair of spiders and either the top end or the bottom end of the main shaft. The main shaft is permitted to rotate with respect to the spiders via the pair of supports while in-situ at the worksite. In certain embodiments, the supports comprise bearing assemblies.

The boring bar further includes a tool arm assembly having one or more tool mounting locations that permit a tool to be removably and operatively mounted to the main shaft in a plurality of selected vertical and radial positions with respect to the main shaft and to rotate with the main shaft while the tool is in contact with the work surface. In certain embodiments the tool arm comprises a tool arm with a first end attached to the main shaft and an opposing second end. The tool arm assembly further comprises a slide plate and a machine slide combination configured to removably and operatively mount a tool to the tool arm. The combination further enables the tool to slide to and to be fixed at a selected vertical and radial position with respect to the main shaft without detaching the tool from the combination. In certain embodiments, the boring bar further includes a quill disposed around and attached to the main shaft, and the tool arm assembly is removably mounted to the quill.

In certain embodiments, the system further comprises a drive control unit (DCU) configured to rotate the main shaft using a drive unit and a variable drive control logic that continuously alters a frequency of the DCU to produce a non-uniform pulsation of the drive unit. In certain other embodiments, the DCU is configured to automatically vary the frequency of the DCU based on a target rotational speed and a target deviation from the rotational speed. In such embodiments, a speed of rotation of the main shaft fluctuates between the target rotational speed and a speed within the target deviation.

In certain other embodiments, the boring bar further comprises a stub shaft disposed adjacent and attached to the top end or bottom end of the main shaft, and a drive control unit configured to operatively rotate the main shaft by directly rotating only the stub shaft. In certain embodiments, each of the pair of spiders is mounted directly and exclusively to the main shaft and neither of the pair of spiders is mounted directly to the stub shaft.

Also disclosed herein is a tool arm assembly for removably mounting a tool to a main shaft of a boring bar system that is sized and configured for removable in-situ placement within a cylindrically-shaped worksite in order to inspect or maintain a work surface that is fixedly and non-removably located at the worksite. The tool arm assembly comprises a tool arm configured to mount to and to extend radially outward from the main shaft such that the tool arm rotates with the main shaft. The tool arm assembly also includes a slide plate and machine slide combination that enables a tool to be removably mounted to the tool arm and to be positioned at a vertical and radial position with respect the main shaft. The combination has a slide plate mounted to the tool arm, the slide plate providing a first positioning member, and a machine slide having at least one tool mounting location. The machine slide further provides a second positioning member that works cooperatively with the first positioning member of the slide plate to enable selective movement of the tool mounting location in a vertical and radial direction with respect to the main shaft. In certain embodiments, the tool arm comprises a pair of spaced apart tool arms, including an upper tool arm and a lower tool arm, with the combination removably connected between the upper and lower tool arms. In certain other embodiments, the combination is mounted to the tool arm via a connector. The connector is placed at one of two or more discrete mounting openings disposed in the tool arm, slide plate, or both in order to provide two or more discrete mounting locations for rough positioning of a tool mounted to the machine slide with respect to the main shaft and work surface. In certain embodiments, the slide plate is mounted to the machine slide via a connector that is placed in a slot disposed in the slide plate, machine slide, or both in order to provide continuous fine positioning of a tool mounted to the machine slide with respect to the main shaft and the work surface.

Also disclosed herein is a method of operating a boring bar system that is sized and configured for removable in-situ placement within a cylindrically-shaped worksite for inspecting or maintaining a work surface that is fixedly and non-removably located at the worksite. The method comprises a first step of providing said boring bar system. The boring bar system includes a boring bar having a vertically oriented main shaft having a top end and a bottom end. The boring bar further includes a pair of spiders having a plurality of outwardly radiating horizontally oriented arms, each of the arms including a fixed end that is fixed to the spider and an opposing end. Also included are a pair of supports that directly and exclusively supports the main shaft and that rotatably joins the main shaft to the pair if spiders. The boring bar also includes a tool arm assembly for removably and operatively mounting a tool to the main shaft. The tool arm assembly removably and operatively mounts a tool to the main shaft and provides two or more discrete mounting locations for rough vertical and radial positioning and also a slot or continuous fine vertical and radial positioning of the tool mounted to the tool arm assembly. A drive control unit (DCU) is also included in the boring bar system and is configured to rotate the main shaft using a drive unit and a variable drive control logic that continuously alters a frequency of the DCU to produce a nonuniform pulsation of the drive unit. The method includes a next step of removably mounting the opposing free end of each of the arms of each spider to the worksite in order to selectively locate a position of each of the top and bottom ends of the main shaft with respect to the worksite. Next, the method teaches mounting a tool to the tool arm assembly at selected rough and fine vertical and radial positions with respect to the main shaft and work surface. Finally, the method teaches the step of, using the DCU, rotating the main shaft about a central vertical axis extending through the top end and bottom end of the main shaft to position the tool at a selected vertical and radial position with respect to the main shaft and work surface. In certain embodiments, the method further comprises the step of continuously varying a frequency of the DCU to continuously maintain a non-uniform pulsation of the drive unit. In certain other embodiments the method further comprises the steps of providing a first SPEED and TRIM setting to the DCU, and, using the DCU, automatically rotating the main shaft based on the first SPEED and TRIM settings while continuously maintaining a non-uniform pulsation of the DCU. The method can optionally further include the steps of providing a second and different SPEED AND TRIM setting to the DCU. After the DCU rotates the main shaft based on the first SPEED and TRIM settings for a selected number of cycles, a set amount of time, or both, the main shaft is then automatically rotated by the DCU based on the second SPEED and TRIM setting while maintaining a non-uniform pulsation of the DCU. In certain embodiments, while the main shaft is rotating, the DCU maintains a rotational drive speed of the main shaft that continuously fluctuates between a maximum speed and a minimum speed based on the SPEED and TRIM settings.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 depicts the general structure and components of a conventional hydropower plant;

FIG. 2 depicts a turbine and turbine enclosure of a conventional hydropower plant;

FIG. 3 is a front elevation view depicting a conventional boring bar having an upper bearing mounted to a stub shaft connected to a main shaft of the boring bar and that is located at a longitudinal position above an upper spider;

FIG. 4 is a section view depicting the boring bar of FIG. 3 and taken along line “4-4”;

FIG. 5 depicts a boring bar system having a drive control unit for providing a variable control logic according to an embodiment of the present invention;

FIG. 6 depicts the boring bar system of FIG. 5 having a machining tool slide attachment point and being located within a turbine enclosure (i.e., above draft tube) and with upper and lower spiders shown attached to mounting points within the enclosure for fixing the boring bar system in place;

FIG. 7A is a cutaway view of a portion of the boring bar system enclosed by a box in FIG. 6 labeled “FIG. 7”, which depicts an upper bearing mounted to a main shaft of the boring bar and located generally at the same longitudinal (vertical) position as the upper spider;

FIG. 7B is a cross-sectional view depicting a simplified portion of the system shown in FIG. 6 along line “7B-7B” that depicts a lower spider having a plurality of arms mounted at a worksite;

FIG. 8 is a graphical representation of an example variable control logic used during the operation of machining tools of the presently-disclosed boring bar system.

FIG. 9 depicts a lower portion of a turbine enclosure and a boring bar system having a lower spider mounted within the lower portion of the enclosure according to an embodiment of the present invention;

FIGS. 10 and 11 depict machining tools mounted to a machining tool slide attachment point of the boring bar system of FIG. 5 in use to machine a work surface (i.e., a discharge ring), where the machining tool advances horizontally and vertically across the face of the discharge ring; and

FIGS. 12 and 13 depict flange rings before and after being machined, respectively, with the machining tool of the boring bar system of FIG. 5.

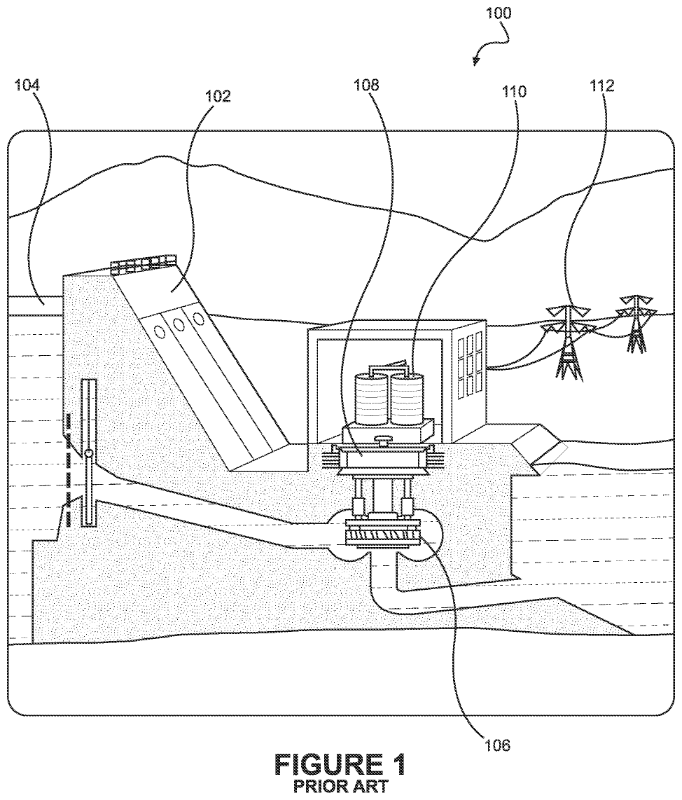

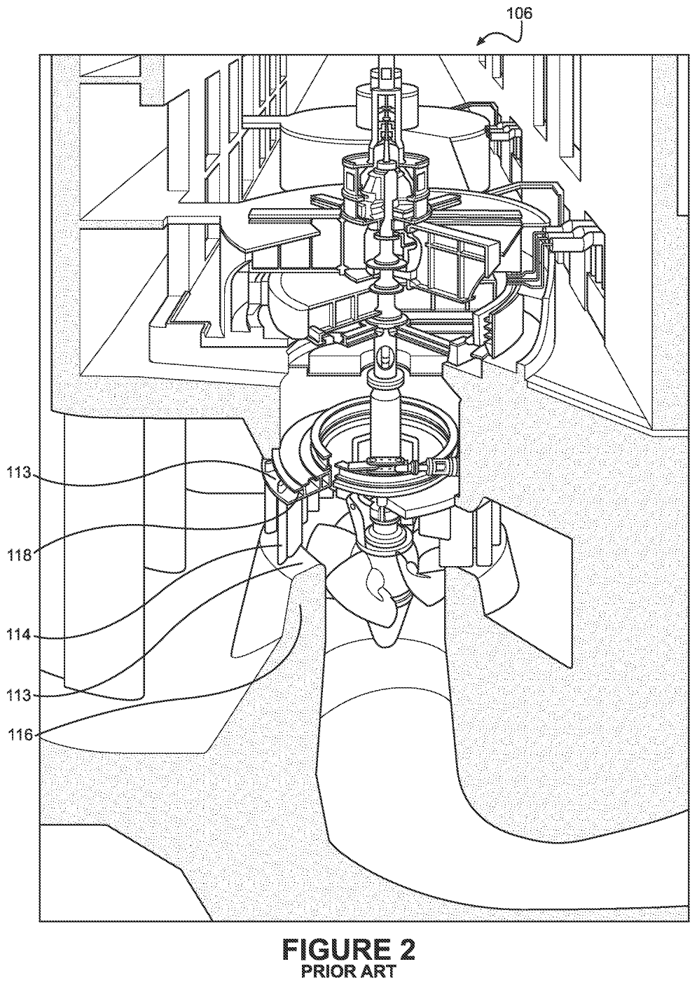

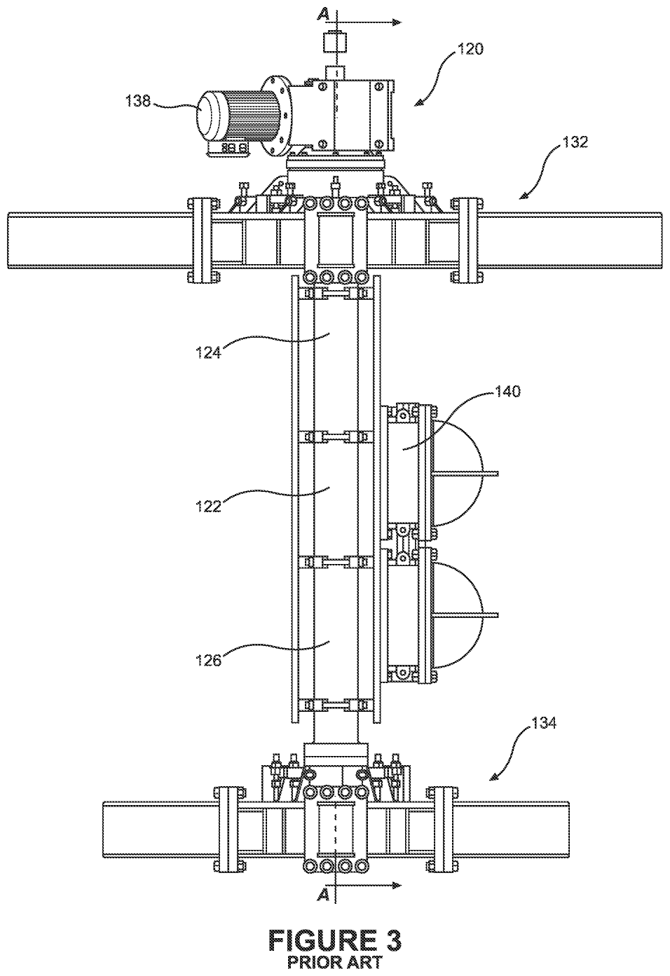

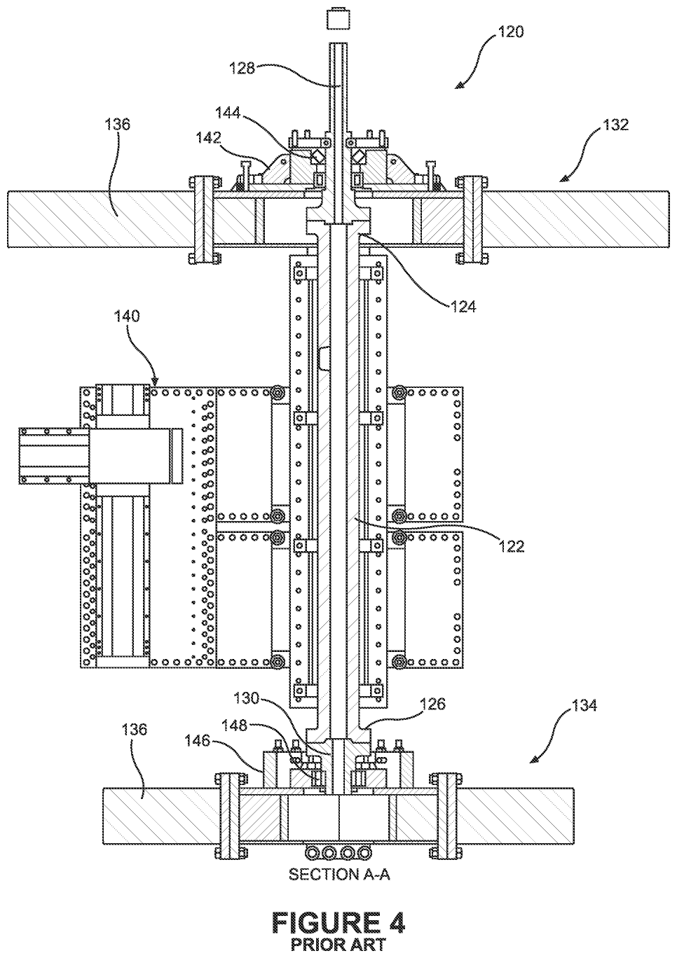

### DETAILED DESCRIPTION

This description of the preferred embodiments of the invention is intended to be read in connection with the accompanying drawings, which are to be considered part of the entire written description of this invention. The drawings are not necessarily to scale, and certain features of the invention may be shown exaggerated in scale or in somewhat schematic form in the interest of clarity and conciseness.

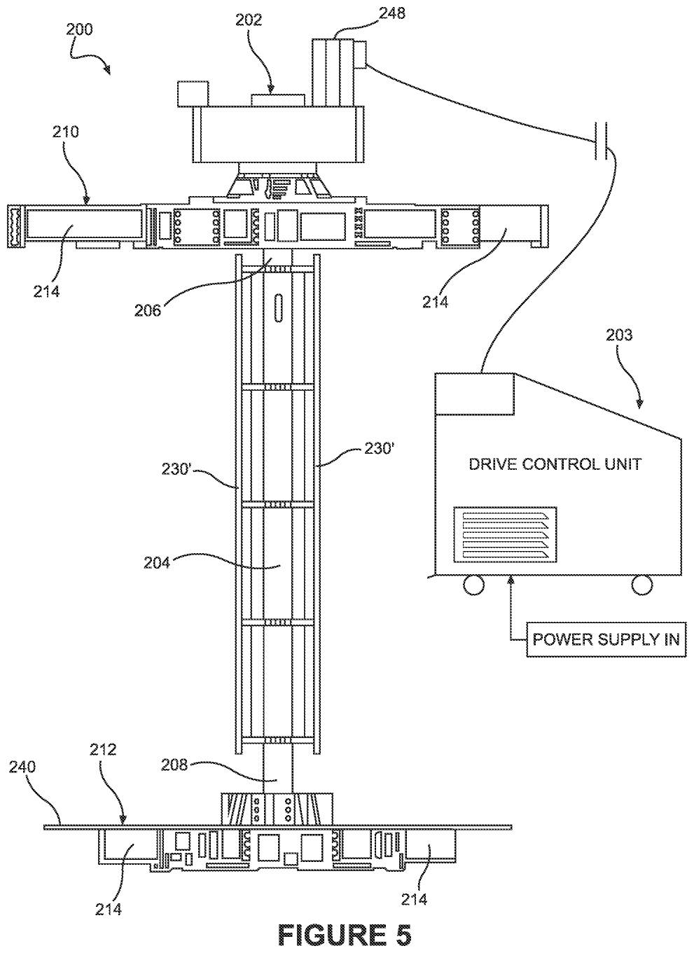

With reference now to FIGS. 5-7B, there is provided a boring bar system 200 having a boring bar 202 and a drive control unit (DCU) 203 for controlling the operation of the boring bar. The boring bar 202 includes a vertically oriented rotating main shaft 204 having a top end 206 and a bottom end 208 with vertical axis Z extending between a center of the top end and the bottom end. An upper stationary spider 210 is located at the top end 206 of the main shaft 204 and a smaller diameter lower stationary spider 212 is located at the bottom end 208 of the main shaft, the two spiders forming a pair. Each of the spiders 210, 212 function as support and positioning devices for correctly positioning or orienting the ends 206, 208 of the main shaft 204 at the selected worksite. The spiders 210, 212 each include a plurality of arms 214 that radiate horizontally outwards from and surround the main shaft 204 such that each of the arms is preferably oriented orthogonal to axis Z. The main shaft 204 is configured to rotate about central vertical axis Z. A fixed end 214A of each arm 214 is fixed to the spider 210/212 and a free end 214B of each arm (i.e., the end located opposite the main shaft 204) that is configured to be removably mounted to a fixed location at the worksite in order to securely fix the spider 210, 212 in place. The lower spider 212 is also provided with a safety work platform 240 that is located on top of the horizontally-oriented arms 214 and that provides a surface on which users may stand, place/store equipment, etc.

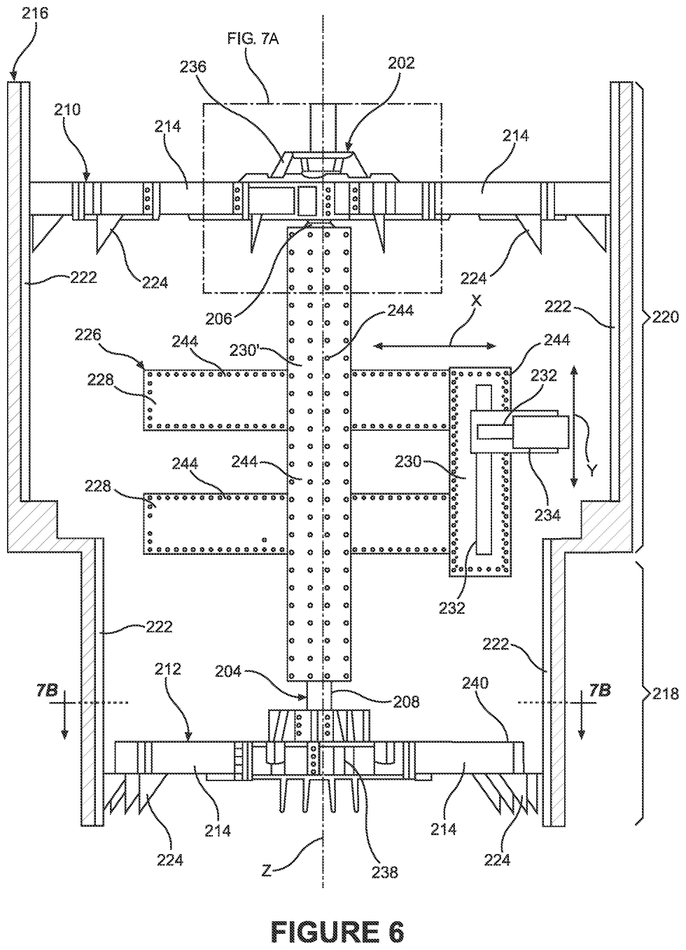

The worksite shown in FIG. 6 is an enclosure 216 for a hydro turbine-powered dam (not shown) that includes a lower section 218 that is generally cylindrical-shaped and a larger upper section 220 that is also and generally cylindrically-shaped. Each of the lower and upper sections 218, 220 of the enclosure 216 includes one or more work surfaces 222 (e.g., stay rings, stay vanes, discharge rings, and flange faces) that surround the boring bar 202 and that may be inspected and maintained using the boring bar system 200. These work surfaces 222 are fixedly and non-removably located at the worksite. A tool arm assembly 226 is attached to and rotates with the main shaft 204. The tool arm assembly 226 preferably includes a tool arm 228 (two are shown in FIG. 6) having a first end that is operatively mounted to the main shaft 204 and a second end with a slide plate 230 that is located (or that can be selectively located) at the second end. The slide plate 230 provides an attachment point onto which one or more positioning members in the form of machine slides 232 may be operatively mounted. In certain other embodiments, positioning members other than machine slides 232 are contemplated (e.g., precision slides, hydraulic actuators, linear actuators, power screws, holes, slots, etc.). These machine slides 232, in turn, enable tools or other equipment (collectively, tools 234) that are useful in inspecting and maintaining the work surfaces 222 to be mounted. The slide plate 230 and slides 232 are sometimes referred to herein as a “slide plate and machine slide combination” or as the “combination.” Preferably, via the combination cooperatively working, the tools 234 may be selectively moved vertically upwards and downwards, as shown by arrow Y, and laterally inwards towards and outwards away from the main shaft 204 (in a radial direction), as shown by arrow X, such that the tools 234 may be correctly located with respect to a work surface without being removed or detached from the tool arm 228 or from the combination. In preferred embodiments, this vertical and lateral (i.e., radial) movement is precisely controlled using horizontal and vertical machine slides 232 mounted to the slide plate 230. In certain preferred embodiments, the tool arm assembly 226 comprises a pair of spaced apart tool arms 228 and the slide plate 230 and slides 232 are mounted between the two tool arms 228.

In certain embodiments, two or more discrete mounting openings 244 are provided along the tool arm 228, slide plate 230, and along a quill 230′ surrounding the main shaft 204. The mounting openings allow the tool arm 228, slide plate 230, and quill 230′ to be disconnected from one another in one configuration, moved, and then reconnected in another different configuration for the purpose of repositioning the tools 234. This provides a rough or general positioning for the tools 234. Fine or specific positioning of the tools 234 is then provided with the machine slides 232, as discussed above. Alternatively, a slot may be disposed within the slide plate 230, machine slides 232, or the tool arm 228, to provide fine or specific positioning of the tools 234, and a connector (e.g., bolts, screws, nails, pins, rivets, key stock, etc.) is placed in the slot to fixedly attach the various parts together.

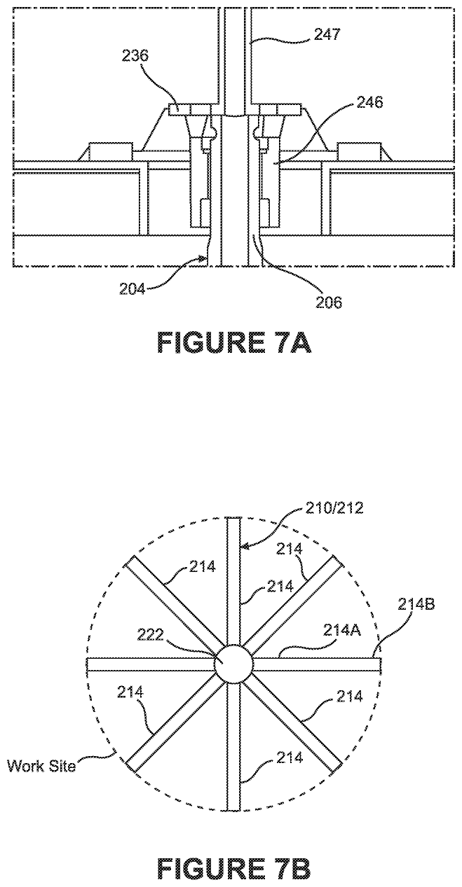

The top and bottom ends 206, 208 of the main shaft 204 are supported by and configured to rotate 360° within bearing assemblies, including a first bearing assembly supported by an upper bearing support bracket 236 located at the upper spider 210 and a second bearing assembly supported by a lower bearing support bracket 238 located at the lower spider 212. In preferred embodiments, support brackets 236, 238 position bearings 246 (shown in FIG. 7) adjacent to the main shaft 204. Positioning the support brackets 236, 238 and, more importantly, the bearings 246 adjacent and exclusively on the main shaft 204 instead of adjacent a stub shaft 247 located at the end of the main shaft, provides increased rigidity without manipulating the mass or size of the boring bar system 200. In fact, in this particular design, a stub shaft 247 is provided only adjacent the top end 206 of the main shaft 204. There is no corresponding stub shaft located adjacent the bottom end 208 of the main shaft 204.

The increased rigidity described above, which results from the positioning of bearing 246 adjacent main shaft 204, results in improved machining results. During inspecting and machining operations, the main shaft 204 may be rotated entirely around (i.e., 360°) about axis Z within the bearing assemblies by a gearmotor drive unit 248, which is located at the top of the main shaft in the illustrated embodiment. The tools 234 are positioned in the correct location adjacent one of the work surfaces 222 by tool arm assembly 226 so that the necessary inspection and maintenance work may be performed.

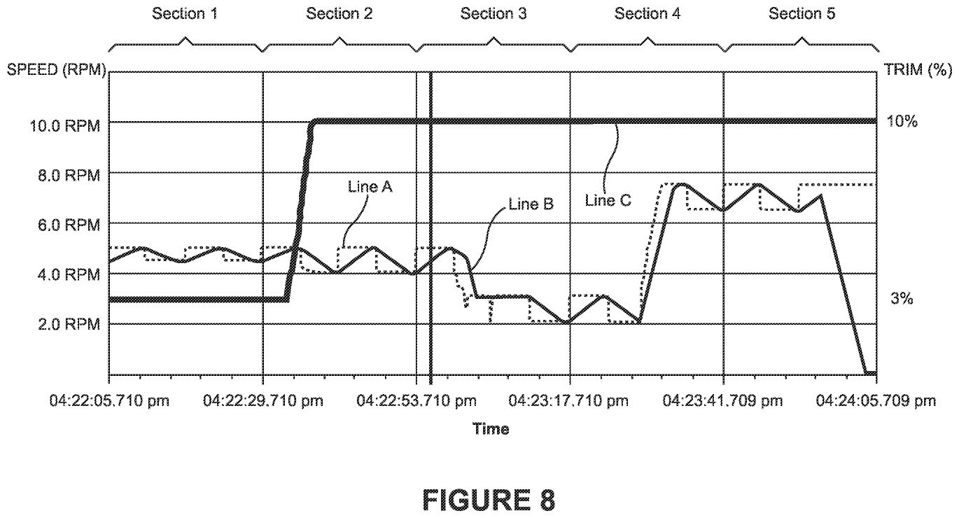

The present invention also includes a method for operating the boring bar 202 with the DCU 203 in such a way that harmonics and the resulting vibrations are greatly reduced or, more preferably, eliminated altogether. The DCU 203 utilizes a variable drive control logic that is a departure from the standard, generally steady state, drive functionality that has been used in the past in controlling rotating machinery. Instead, as graphically depicted in FIG. 8, the control logic continuously alters the frequency to the drive unit 248. This provides an alteration or interruption of frequencies in the drive unit 248, which establishes a non-uniform pulsation of the drive system that drives that rotation of the main shaft 204. This, in turn, minimizes the potential for the development of undesirable harmonics during machining operations.

The DCU 203 is configured to automatically modify a DRIVE setting (i.e., the target speed) for the drive unit 248 between a minimum target speed and a maximum target speed. The DCU 203 is provided with two inputs for controlling the maximum and minimum speeds for the DRIVE setting and both are preferably input manually by a user via potentiometer. The first input is a SPEED setting, which is the maximum rotating speed of the main shaft 204 that the DCU 203 will permit. The SPEED setting may be limited such that it can be set within a specific range, below a set maximum, or above a set minimum. The second input is a TRIM setting, which is deduction or negative speed adjustment that sets the minimum rotating speed of the main shaft 204 that the DCU 203 will permit. Preferably, the TRIM setting is adjusted by the user within a set range (e.g., between 3% and 10% of the maximum target speed) based on the user's observations of the work surface 222. The DCU 203 is configured to automatically and continuously fluctuate between the specified maximum speed value (i.e. SPEED) and the specified minimum speed value (i.e., SPEED minus TRIM) over a specified period of time or at a specified rate of increase or decrease. In preferred embodiments, as soon as the maximum speed value is reached, the speed begins to be reduced by the DCU 203. Then, once the minimum speed value is reached, the speed begins to be increased by the DCU 203. In certain embodiments, after a specific number of cycles, a set amount of time, or both, one or more of the SPEED and TRIM values may be modified by a user in order to produce yet a different pulsation of the drive unit 248. In other embodiments, the DCU varies the frequency of the DCU based on a target rotational speed and a target deviation from the target rotational speed. In operation, the rotational speed of the main shaft fluctuates while remaining between the target rotational speed and a speed within the target deviation.

With reference to FIG. 8, Line A represents the target drive speed (i.e., the goal or target speed), Line B represents the instantaneous speed, and Line C represents the TRIM value. There are five sections (i.e., Section 1, Section 2, etc. . . . ) that are each approximately 24 seconds in length. At approximately the beginning/end of each of these Sections, one or both of the SPEED and TRIM settings are modified. The values for the SPEED (i.e., the target maximum speed), TRIM (i.e., speed reduction), and resulting target minimum speed in each of these Sections are tabulated below.

| | SPEED | | TRIM | (Target |
|---|---|---|---|---|
| SECTION | (Target Max. Speed) | | (Speed Reduction) | Min. Speed) |
| 1 | 5 | rpm | 3% | 4.7 rpm |
| | (50% of 10 RPM | | (of 10 RPM | |
| | Capacity) | | Capacity) | |
| 2 | 5 | RPM | 10% | 4.0 rpm |
| | (50% of 10 RPM | | (of 10 RPM | |
| | Capacity) | | Capacity) | |
| 3 | 3 | RPM | 10% | 2.0 rpm |
| | (30% of 10 RPM | | (of 10 RPM | |
| | Capacity) | | Capacity) | |
| 4 | 7.5 | RPM | 10% | 6.5 rpm |
| | (75% of 10 RPM | | (of 10 RPM | |
| | Capacity) | | Capacity) | |
| 5 | 0 | RPM | 10% | 0.0 rpm |

| | |
|---|---|
| (0% of 10 RPM | (of 10 RPM |
| Capacity) | Capacity) |

The drive setting alternates between a positive drive, where the drive speed is increasing, and a negative drive, where the drive speed is decreasing, each time that the instantaneous drive speed meets the drive setting. In this particular case, the time required to reduce the speed from the maximum speed to the minimum speed is approximately 6 second. This time may be increased or decreased in order to provide the desired balance between machining/processing speed and quality of finish of the work surface 222. As a result, the instantaneous drive speed (Line B) oscillates to provide a sawtooth, sinusoidal, or other similar waveform.

As shown in the given example, in Section 1, SPEED is set to 5 rpm (or 50% of a 10 rpm limit for this particular drive unit) and TRIM is set to 3% of the 10 rpm limit for this drive unit. The DCU 203 automatically increases the speed (i.e., positive drive) until the maximum speed (i.e., SPEED) is reached and then the DCU automatically begins to reduce the speed (i.e., negative drive) until the minimum speed (i.e., SPEED minus TRIM) is reached. In Section 2, SPEED remains the same and TRIM is set to 10%, where 3% is minimum and 10% is maximum for the TRIM setting in this particular example. Next, in Section 3, SPEED is set to 3 rpm while TRIM remains at 10%. In Section 4, SPEED is increased to about 7.5 rpm with TRIM remaining constant at 10%. Finally, in Section 5, SPEED is decreased to zero. Since SPEED cannot be further reduced, TRIM does not impact the instantaneous speed in Section 5.

As shown above, DCU 203 preferably provides constant variation of frequency of the drive unit 248. This variation or interruption of frequency establishes a non-uniform pulsation of the drive unit 248, which minimizes the potential for the development of undesirable harmonics during machining operations. As a result, the use of this method provides a noticeable improvement in the resulting quality in the machined surfaces and improved efficiency and speed of the machining process. Among other improvements, this process provides an improved surface finish, faster (i.e., more aggressive) material removal, faster indexing speed, and improved interrupted cutting capability.

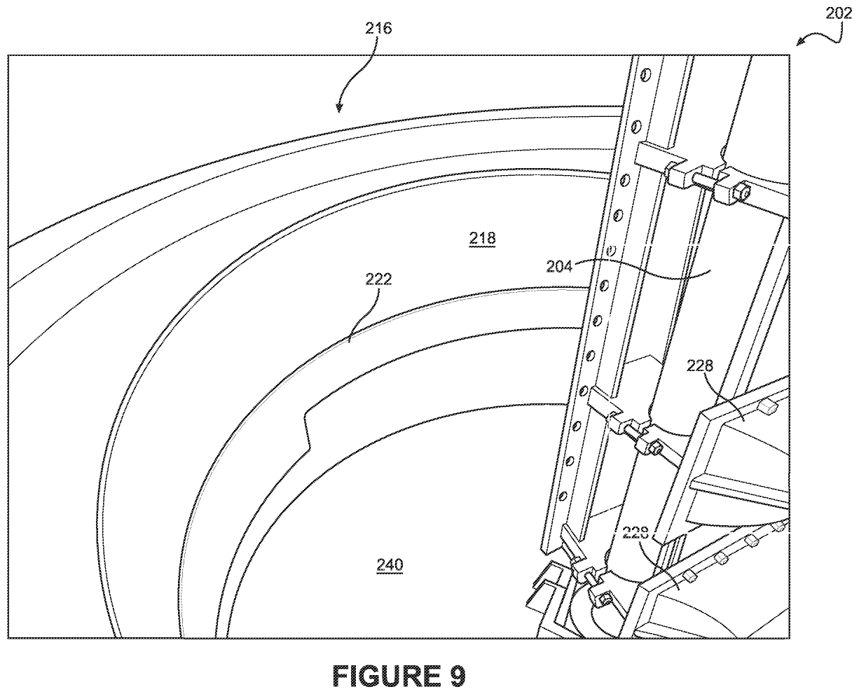

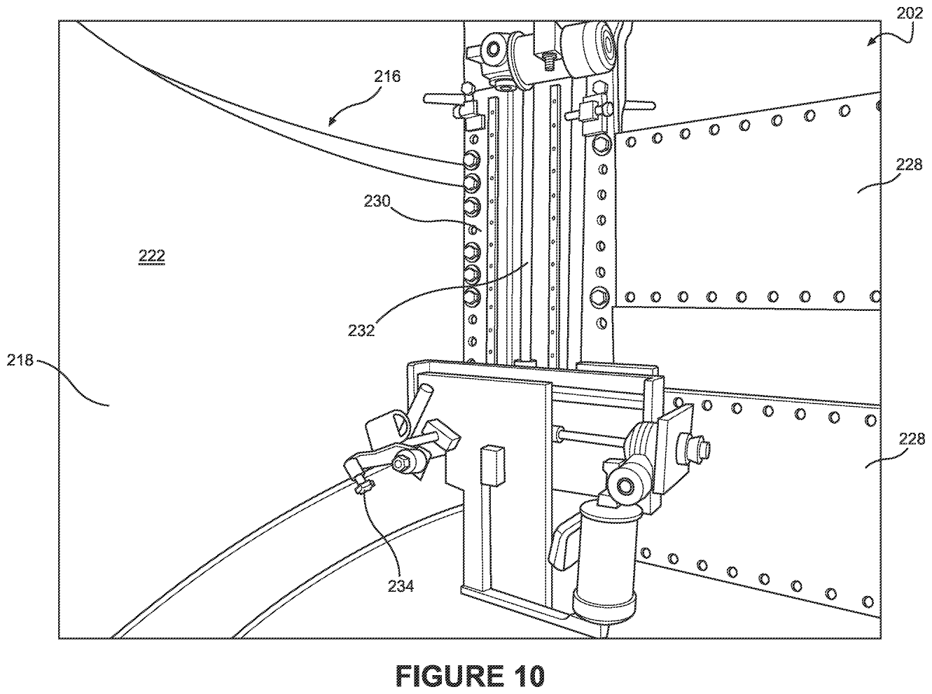

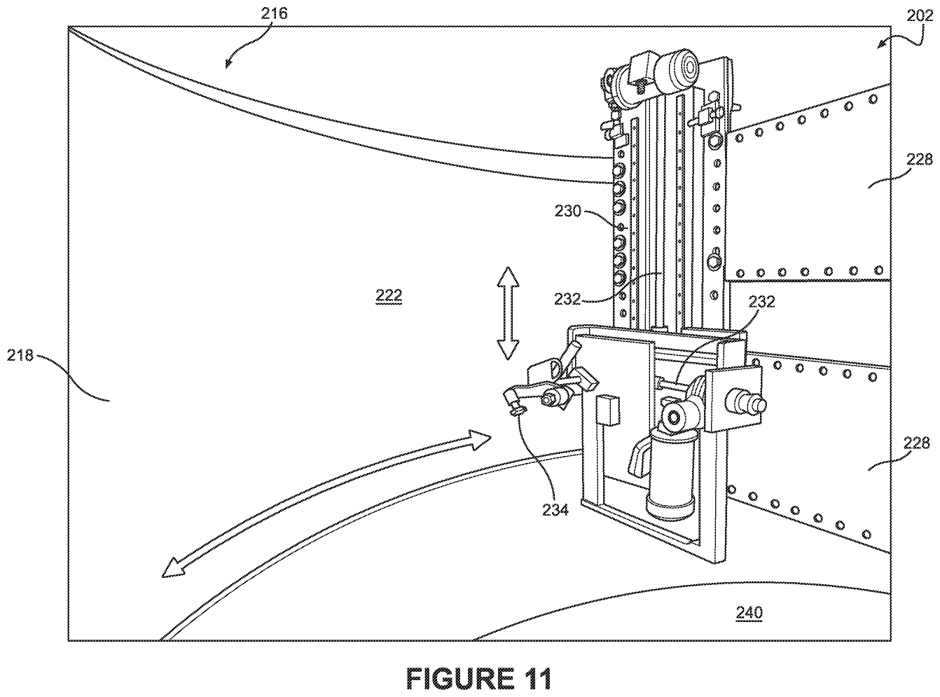

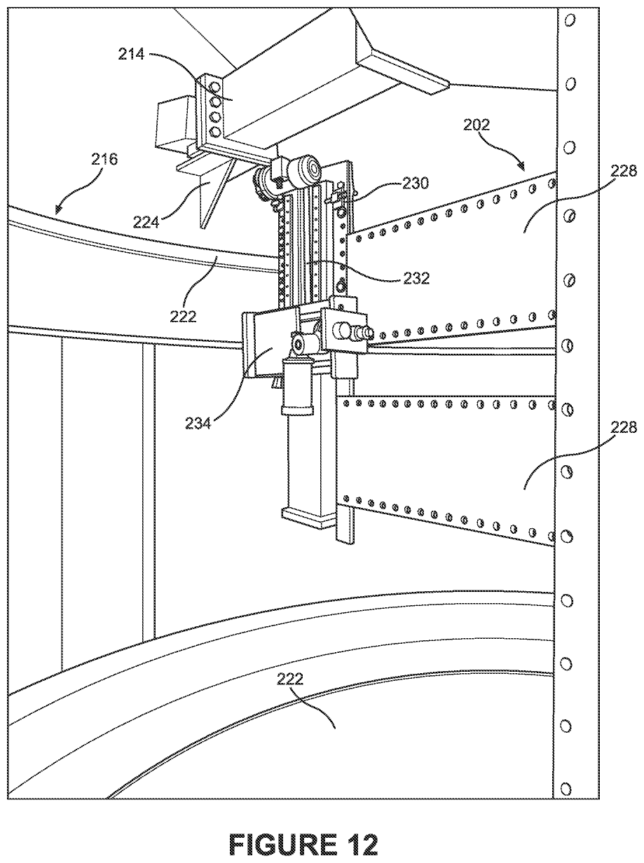

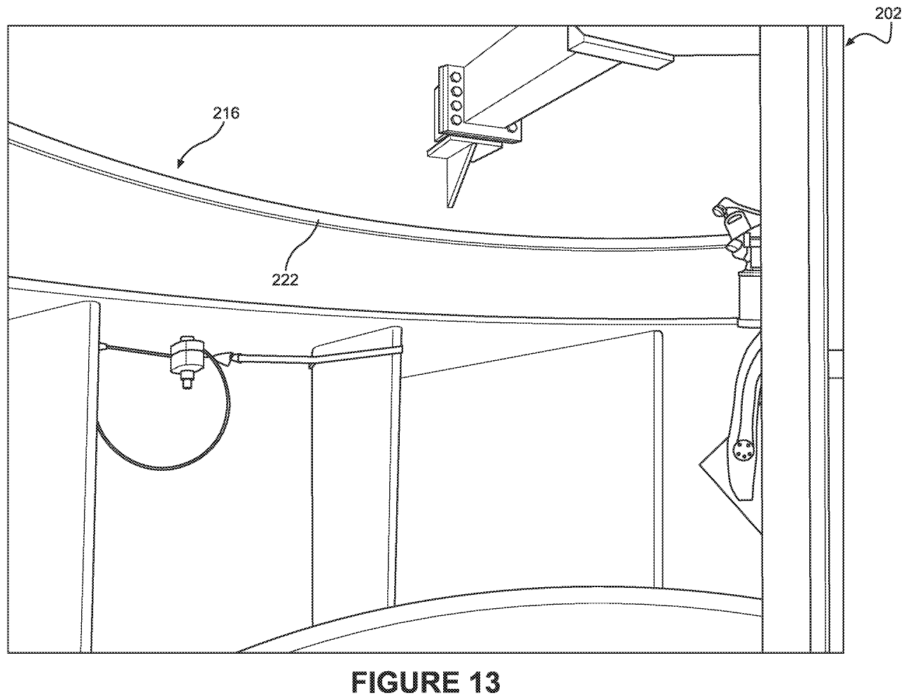

Finally, FIGS. 9-13 illustrate use of a boring bar 202 in inspecting and maintaining an enclosure 216. FIG. 9 depicts a lower section 218 of a turbine enclosure 216 with peripheral work surface 222 and a boring bar 202 having a lower spider mounted within the enclosure and providing a work platform 240 for use in inspecting and maintaining the work surface. FIGS. 10 and 11 depict machining tools 234 mounted to a tool arm 228 of the boring bar 202 via slides 232. These tools 234 are shown in use to machine a work surface 222 (i.e., a discharge ring), where the machining tool advances horizontally and vertically across the face of the discharge ring. Finally, FIGS. 12 and 13 depict a work surface 222 (i.e. flange rings) before and after being machined, respectively, with the machining tool 234 of the boring bar system of FIG. 5.

Although this description contains many specifics, these should not be construed as limiting the scope of the invention but as merely providing illustrations of some of the presently preferred embodiments thereof, as well as the best mode contemplated by the inventor of carrying out the invention. The invention, as described and claimed herein, is susceptible to various modifications and adaptations as would be appreciated by those having ordinary skill in the art to which the invention relates.

What is claimed is:

1. A boring bar system sized and configured for removable in-situ placement within a cylindrically-shaped worksite configured for use in inspecting or maintaining a work surface that is fixedly and non-removably located at the worksite, the system comprising:
a boring bar having:
a vertically oriented rotating main shaft having a top end and a bottom end and being configured to rotate entirely around about a central vertical axis extending through a center of the top end and bottom end of the main shaft;
a pair of stationary spiders configured to support and to correctly locate a position of each of the top and bottom ends of the main shaft with respect to the worksite, each of the pair of spiders having a plurality of outwardly radiating horizontally oriented arms, wherein each of the arms includes a fixed end that is fixed to the spider and an opposing free end that is configured to removably mount to the worksite;
a pair of supports that are each directly and exclusively mounted between one of the pair of spiders and either the top end or bottom end of the main shaft such that the main shaft is permitted to rotate with respect to the spiders via the pair of supports while in-situ at the worksite; and
a tool arm assembly having one or more tool mounting locations that permit a tool to be removably and operatively mounted to the main shaft in a plurality of selected vertical and radial positions with respect to the main shaft and to rotate with the main shaft while the tool is in contact with the work surface.

2. The system of claim 1 wherein the supports comprise bearing assemblies.

3. The system of claim 1 wherein the tool arm assembly comprises:
a tool arm with a first end attached to the main shaft and an opposing second end; and
a slide plate and machine slide combination configured to removably and operatively mount a tool to the tool arm and to enable the tool to slide to and to be fixed at a selected vertical and radial positions with respect to the main shaft without detaching the tool from the combination.

4. The system of claim 1 further comprising a drive control unit (DCU) configured to rotate the main shaft using a drive unit and a variable drive control logic that continuously alters a frequency of the DCU to produce a non-uniform pulsation of the drive unit.

5. The system of claim 4 wherein the DCU is configured to automatically vary the frequency of the DCU based on a target rotational speed and a target deviation from the target rotational speed, such that a speed of rotation of the main shaft fluctuates between the target rotational speed and a speed within the target deviation.

6. The system of claim 1 wherein each of the pair of spiders further comprises an upper horizontal surface and wherein a safety work platform is disposed on the upper horizontal surface of at least one of the spiders.

7. The system of claim 1 wherein the boring bar further comprises a stub shaft disposed adjacent and attached to the top end or bottom end of the main shaft; and a drive control unit configured to operatively rotate the main shaft by directly rotating only the stub shaft.

8. The system of claim 1 wherein the boring bar further comprises a stub shaft mounted to either the top end or the bottom end of the main shaft, wherein each of the pair of spiders is mounted directly and exclusively to the main shaft and neither of the pair of spiders is mounted directly to the stub shaft.

9. The system of claim 1 wherein the boring bar further includes a quill disposed around and attached to the main shaft, wherein the tool arm assembly is removably mounted to the quill.

10. The system of claim 1 wherein the worksite is a hydro turbine-powered dam and wherein the work surface comprises at least one of a stay ring, a stay vane, a discharge ring, or a flange.

11. A tool arm assembly for removably mounting a tool to a rotating main shaft of a boring bar system that is sized and configured for removable in-situ placement within a cylindrically-shaped worksite in order to inspect or maintain a work surface that is fixedly and non-removably located at the worksite, the tool arm assembly comprising:
a tool arm configured to mount to and to extend radially outward from the main shaft such that the tool arm rotates with the main shaft; and
a slide plate and machine slide combination that enables a tool to be removably mounted to the tool arm and to be positioned at a vertical and radial position with respect to the main shaft, the combination having:
a slide plate mounted to the tool arm and providing a first positioning member; and
a machine slide having at least one tool mounting location and providing a second positioning member that works cooperatively with the first positioning member of the slide plate to enable selective movement of the tool mounting location in a vertical and radial direction with respect to the main shaft.

12. The tool arm assembly of claim 11 wherein the tool arm comprises a pair of spaced apart tool arms, including an upper tool arm and a lower tool arm, with the combination removably connected between the upper and lower tool arms.

13. The tool arm assembly of claim 11 wherein the combination is mounted to the tool arm via a connector that is placed at one of two or more discrete mounting openings disposed in the tool arm, slide plate, or both in order to provide two or more discrete mounting locations for rough positioning of a tool mounted to the machine slide with respect to the main shaft and work surface.

14. The tool arm assembly of claim 13 wherein the slide plate is mounted to the machine slide via a connector that is placed in a slot disposed in the slide plate, machine slide, or both in order to provide continuous fine positioning of a tool mounted to the machine slide with respect to the main shaft and work surface.

15. The tool arm assembly of claim 11 wherein the slide plate is mounted to the machine slide via a connector that is placed in a slot disposed in the slide plate, machine slide, or both in order to provide continuous fine positioning of a tool mounted to the machine slide with respect to the main shaft and the work surface.

16. A method of operating a boring bar system that is sized and configured for removable in-situ placement within a cylindrically-shaped worksite for inspecting or maintaining a work surface that is fixedly and non-removably located at the worksite, the method comprising the steps of:
providing said boring bar system, wherein said system includes:
a boring bar having:
a vertically oriented main shaft having a top end and a bottom end;
a pair of spiders having a plurality of outwardly radiating horizontally oriented arms, wherein each of the arms includes a fixed end that is fixed to the spider and an opposing free end;
a pair of supports that directly and exclusively supports the main shaft and that rotatably joins the main shaft to the pair of spiders;
a tool arm assembly for removably and operatively mounting a tool to the main shaft, the tool arm assembly providing two or more discrete mounting locations for rough vertical and radial positioning and also a slot for continuous fine vertical and radial positioning of the tool mounted the tool arm assembly; and
a drive control unit (DCU) configured to rotate the main shaft using a drive unit and a variable drive control logic that continuously alters a frequency of the DCU to produce a non-uniform pulsation of the drive unit,
removably mounting the opposing free end of each of the arms of each spider to the worksite in order to selectively locate a position of each of the top and bottom ends of the main shaft with respect to the worksite;
mounting a tool to the tool arm assembly at selected rough and fine vertical and radial positions with respect to the main shaft and work surface; and
using the DCU, rotating the main shaft about a central vertical axis extending through the top end and bottom end of the main shaft to position the tool at a selected vertical and radial position with respect to the main shaft and work surface.

17. The method of claim 16 further comprising the step of continuously varying a frequency of the DCU to continuously maintain a non-uniform pulsation of the drive unit.

18. The method of claim 17 further comprising the steps of:
providing a first SPEED and TRIM setting to the DCU; and
using the DCU, automatically rotating the main shaft based on the first SPEED and TRIM while continuously maintaining a non-uniform pulsation of the DCU.

19. The method of claim 18 further comprising the steps of:
providing a second and different SPEED and TRIM setting to the DCU,
wherein, after the DCU rotates the main shaft based on the first SPEED and TRIM for a selected number of cycles, a set amount of time, or both, the main shaft is then automatically rotated by the DCU based on the second SPEED and TRIM setting while maintaining a non-uniform pulsation of the DCU.

20. The method of claim 19 wherein, while the main shaft is rotating, the DCU maintains a rotational drive speed of the main shaft that continuously fluctuates between a maximum speed and a minimum speed based on the SPEED and TRIM settings.
